(19) United States
(12) Patent Application Publication
(10) Pub. No.: US 2013/0265016 A1
(43) Pub. Date: Oct. 10, 2013

(54) Direct Current Converter for Bootstrap Circuit

(71) Applicants: Shao-Te Chang, Yilan County (TW); Chun-Kai Hsu, New Taipei City (TW)

(72) Inventors: Shao-Te Chang, Yilan County (TW); Chun-Kai Hsu, New Taipei City (TW)

(21) Appl. No.: 13/535,372

(22) Filed: Jun. 28, 2012

(30) Foreign Application Priority Data
Apr. 6, 2012 (TW) 101112252

(51) Int. Cl. G05F 1/595

(52) U.S. Cl. 323/271

(57) ABSTRACT

A direct current converter for converting an input voltage to an output voltage, includes a driving-stage circuit having an upper switch and a lower switch for converting the input voltage to a switch signal according to an upper switch control signal and a lower switch control signal and transmitting the switch signal through an output terminal, an output-stage circuit for converting the switch signal to the output voltage, a bootstrap circuit, an upper switch driving circuit for generating the upper switch control signal, and a control module for detecting a characteristic of the bootstrap circuit for generating the lower switch control signal accordingly, and controlling the upper switch driving circuit to generate the upper switch control signal.

### BACKGROUND OF THE INVENTION

1. Field of the Invention

The present invention relates to a direct current (DC) converter for a bootstrap circuit, and more particularly, to a DC converter which has circuit protection mechanism capable of preventing an upper switch from being damaged.

2. Description of the Prior Art

An electronic device includes various components, each of which may operate at different voltage levels. Therefore, a DC converter is definitely required to adjust (step up or down) and stabilize the voltage level in the electronic device. Originating from a buck (or step down) converter and a boost (or step up) converter, various types of DC converters are accordingly customized to meet different power requirements. As implied by the names, the buck converter is utilized for stepping down a DC voltage of an input terminal to a default voltage level, and the boost converter is for stepping up the DC voltage of the input terminal . With the advancement of modern electronics technology, both of the buck converter and the boost converter are modified and customized to conform to different architectures or to meet different requirements.

For example, please refer to FIG. 1, which is a schematic diagram of a conventional DC converter 10. The DC converter 10 includes a driving-stage circuit 100, an output-stage circuit 102, a control module 104, a bootstrap circuit 106 and an upper switch driving circuit 108, for converting an input voltage Vᵢₙ to a stable output voltage Vₒᵤₜ which is lower than the input voltage Vᵢₙ. In detail, the driving-stage circuit 100 includes an upper switch Q1 and a lower switch Q2. The driving-stage circuit 100 controls states of the upper switch Q1 and the lower switch Q2 according to an upper switch control signal V_CTRL_U generated by the upper switch driving circuit 108 and a lower switch control signal V_CTRL_L generated by the control module 104, such that the upper switch Q1 and the lower switch Q2 switch between the enable and disable states respectively. That is, the upper switch Q1 is enabled and the lower switch Q2 is disabled, and then the upper switch Q1 is disabled and the lower switch Q2 is enabled, so as to generate a switch signal SS on an output terminal X to the output-stage circuit 102. The output-stage circuit 102 includes an inductor L and a capacitor C, coupled between the output terminal X of the driving-stage circuit 100 and a ground terminal V_{gnd} keeps the inductor L operating between the charge and discharge states according to the switch signal SS transmitted by the driving-stage circuit 100, and maintains the output voltage Vₒᵤₜ with a predefined voltage value by cooperating with the voltage stabilization function of the capacitor C. The bootstrap circuit 106, which is coupled between a bootstrap voltage terminal V_{cc} and the output terminal X of the driving-stage circuit 100, includes a bootstrap capacitor C_BS and a diode D_BS. The bootstrap circuit 106 is used for providing a stable voltage source to the upper switch driving circuit 108.

As can be seen from the above, the control module 104 controls the states of the upper switch Q1 and the lower switch Q2 through the upper switch control signal V_CTRL_U generated by the upper switch driving circuit 108 and the lower switch control signal V_CTRL_L generated by the control module 104, to adjust the switch frequency between the charge and discharge status, so as to generate the desired output voltage Vₒᵤₜ. However, in the DC converter 10, when the voltage difference between the two sides of the bootstrap capacitor C_BS is over-low, the gate-source bias of the upper switch Q1 will be over-low. If the upper switch Q1 is not disabled at this moment, the upper switch Q1 may enter to the sub-threshold region and the resistance value of the upper switch Q1 increases, causing the power of the upper switch Q1 to be over-high, such that the upper switch Q1 is damaged. In such a condition, how to disable the upper switch Q1 according to the voltage difference between the two sides of the bootstrap capacitor C_BS timely and accurately has become a main focus of the industry.

### SUMMARY OF THE INVENTION

It is therefore an objective of the present invention to provide a direct current converter for a bootstrap circuit, to improve disadvantages of the prior art.

The present invention discloses a direct current converter for converting an input voltage to an output voltage. The direct current converter includes a driving-stage circuit including an upper switch and a lower switch for converting the input voltage to a switch signal according to a first control signal and a second control signal and transmitting the switch signal through an output terminal, an output-stage circuit coupled to the output terminal of the driving-stage circuit for converting the switch signal to the output voltage, a bootstrap circuit coupled between a high level voltage terminal and the output terminal of the driving-stage circuit, an upper switch driving circuit coupled to the driving-stage circuit and the high level voltage terminal, for generating the upper switch control signal, and a control module coupled to bootstrap circuit, the upper switch driving circuit and the lower switch of the driving-stage circuit, for detecting a characteristic of the bootstrap circuit, generating the lower switch control signal accordingly, and controlling the upper switch driving circuit to generate the upper switch control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional direct current converter.

FIG. 2 is a schematic diagram of a direct current converter according to an embodiment of the present invention.

FIG. 3 is a schematic diagram of a detection unit.

FIG. 4 is a schematic diagram of a detection unit according to an embodiment of the present invention.

### DETAILED DESCRIPTION

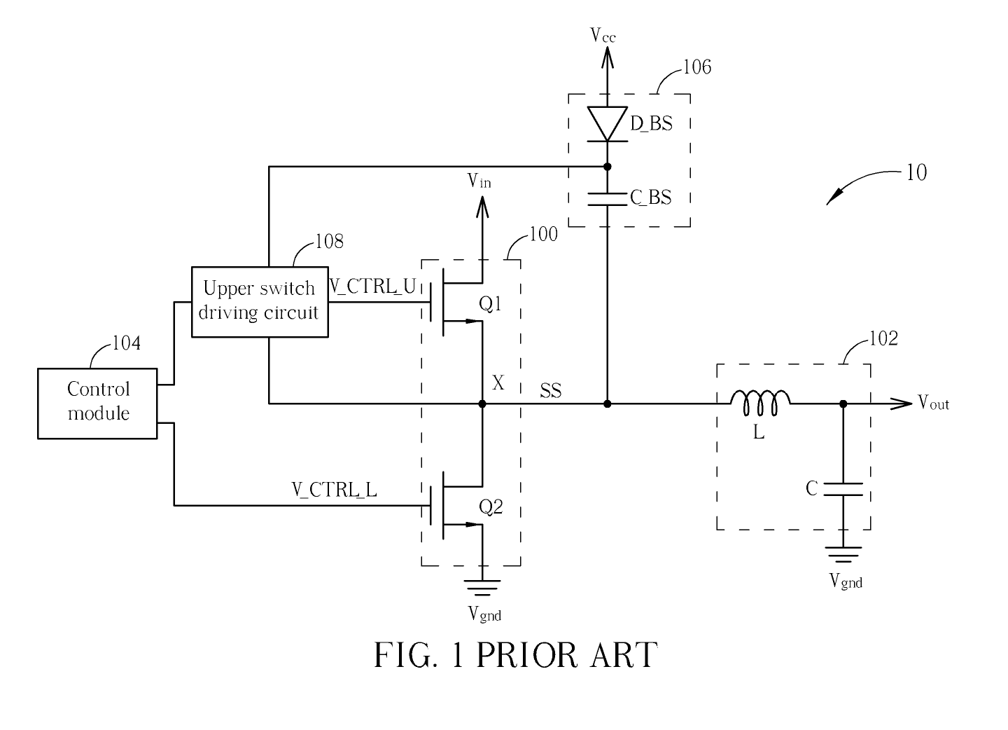

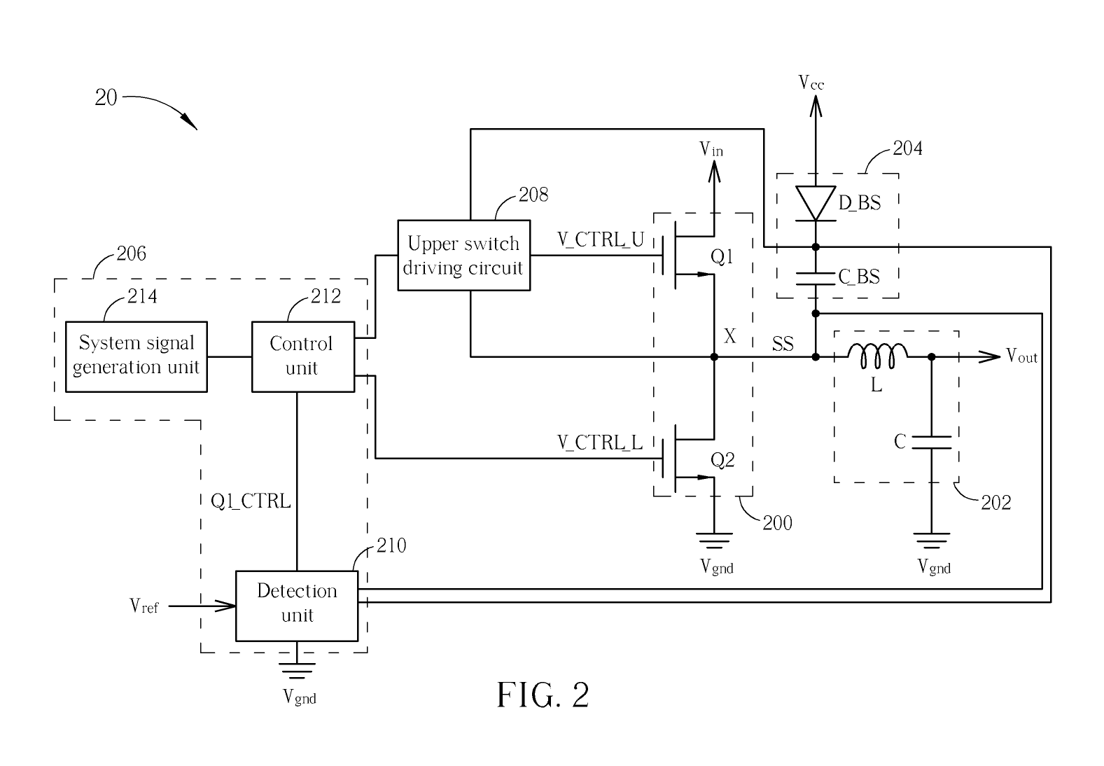

Please refer to FIG. 2, which is a schematic diagram of a direct current (DC) converter 20 according to an embodiment of the present invention. The DC converter 20 includes a driving-stage circuit 200, an output-stage circuit 202, a bootstrap circuit 204, a control module 206 and an upper switch driving circuit 208, wherein the control module 206 includes a detection unit 210, a control unit 212 and a system signal generation unit 214. By comparing FIG. 2 with FIG. 1, one can know that the driving-stage circuit 200, the output-stage circuit 202, the bootstrap circuit 204 and the upper switch driving circuit 208 of the DC converter 20 are substantially similar to the driving-stage circuit 100, the output-stage circuit 102, the bootstrap circuit 106 and the upper switch driving circuit 108 of the DC converter 10, and thus the same components are denoted by the same symbols of FIG. 1. The operation of the DC converter 20 is substantially similar to that of the DC converter 10, and is not narrated hereinafter. The difference between the DC converter 20 and the DC converter 10 is that the DC converter 20 adjusts operations and realizations of the control module 206, and the upper switch is disabled when a voltage difference detected between the two sides of the bootstrap capacitor C_BS of the bootstrap circuit 204 is over-low, so as to achieve the circuit protection function of the DC converter.

In detail, in the control module 206, the detection unit 210 is used for detecting a characteristic of the bootstrap circuit 204 and comparing the characteristic with a reference voltage V_{ref} to generate a compared result Q1_CTRL. In the present invention, a characteristic of the bootstrap circuit 204 is the voltage difference between the two sides of the bootstrap capacitor C_BS. The system signal generation unit 214 is used for generating a system signal to give feedback on the compared result Q1_CTRL. The control unit 212 controls the upper switch driving circuit 208 to generate an upper switch control signal V_CTRL_U according to the compared result Q1_CTRL transmitted by the detection unit 210 and the system signal transmitted by the system signal generation unit 214, so as to control the switch state of the upper switch Q1. For example, when the voltage difference between the two sides of the bootstrap capacitor C_BS is less than the reference voltage V_{ref}, the compared result Q1_CTRL generated by the detection unit 210 is used for indicating to the control unit 212 to control the upper switch driving circuit 208 to generate the upper switch control signal V_CTRL_U accordingly, switching the upper switch Q1 to the disabled state, in order to prevent the upper switch Q1 from entering to a sub-threshold region and the resistance value of the upper switch Q1 increases, causing the power of the upper switch Q1 to be over-high, such that the upper switch Q1 is damaged.

In short, in the present invention, the compared result Q1_CTRL is generated from detecting a characteristic of the bootstrap circuit 204 by the detection unit 210 of the control module 206 and comparing the characteristic with the reference voltage V_{ref} . The control unit 212 indicates the upper switch driving circuit 208 to generate the upper switch control signal V_CTRL_U for switching off the upper switch Q1 according to the compared result Q1_CTRL, so as to achieve the objective of protecting the DC converter 20.

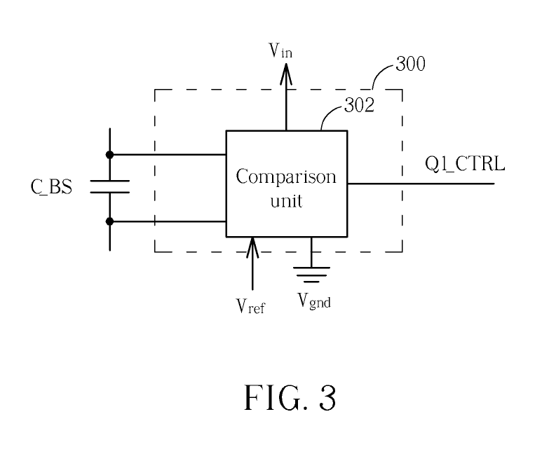

As mentioned above, the bootstrap circuit 204 is detected by the detection unit 210 and the compared result Q1_CTRL is generated by the detection unit 210. Please refer to FIG. 3, which is a schematic diagram of a detection unit 300. The detection unit 300 is an implementation of the detection unit 210. The detection unit 300 mainly includes a comparison unit 302, which is coupled to two voltage input terminals being measured and a reference voltage terminal, for outputting one compared result. The DC converter 20 of the present invention can utilize the detection unit 300 to detect the two sides of the bootstrap capacitor C_BS, obtain the voltage difference between the two sides of the bootstrap capacitor C_BS via the comparison unit 302, and compare the voltage difference between the two sides of the bootstrap capacitor C_BS with the reference voltage V_{ref} to obtain the compared result Q1_CTRL. Note that, the comparison unit 302 usually includes a high-voltage circuit, for comparing the voltage difference between the two sides of the bootstrap capacitor C_BS with the reference voltage V_{ref} directly.

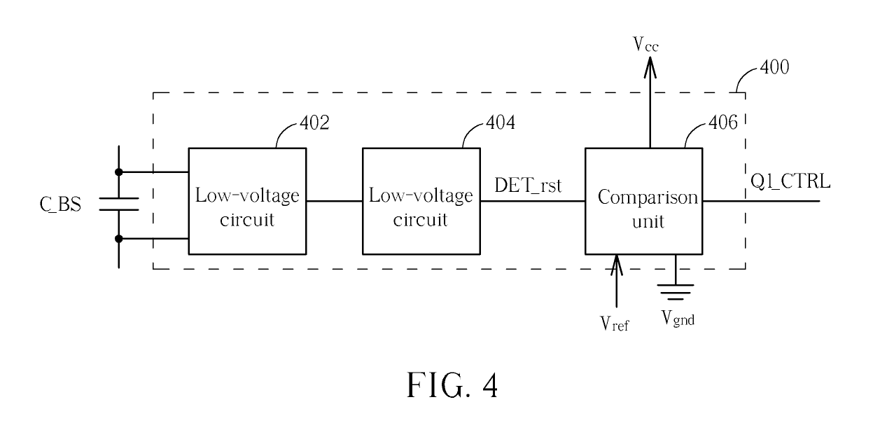

In addition to utilizing the detection unit 300, the present invention further discloses another implementation of the detection unit 210. Please refer to FIG. 4, which is a schematic diagram of a detection unit 400 according to an embodiment of the present invention. The detection unit 400 is another implementation of the detection unit 210 shown in FIG. 2. The detection unit 400 includes low-voltage circuits 402, 404 and a comparison unit 406. The low-voltage circuit 402 converts the voltage difference between the two sides of the bootstrap capacitor C_BS to a current information. The low-voltage circuit 404 converts the current information transmitted by the low-voltage circuit 402 to a detection result DET_rst with voltage form, where the low-voltage circuits 402, 404 are mutually equivalent. The comparison unit 406 includes one low-voltage circuit, for comparing the voltage difference between the two sides of the bootstrap capacitor C_BS with the reference voltage V_{ref}. The advantages of utilizing the equivalent low-voltage circuits are that the fully matched low-voltage circuits 402, 404 can be achieved by utilizing low-voltage components, and therefore the voltage difference between the two sides of the bootstrap capacitor C_BS can be obtained simply and accurately.

In the prior art, if the voltage difference between the two sides of the bootstrap capacitor C_BS is over-low, the gate-source bias of the upper switch will be over-low. If the upper switch Q1 is not disabled at this moment, the upper switch Q1 may enter to the sub-threshold region, and the resistance value of the upper switch Q1 increases, causing the power of the upper switch Q1 to be over-high, such that the upper switch Q1 is damaged. In comparison, the DC converter of the present invention can disable the upper switch Q1 when the detected voltage difference between the two sides of the bootstrap capacitor of the bootstrap circuit is over-low, so as to protect the circuit of the DC converter.

To sum up, the DC converter of the present invention can disable the upper switch when the voltage difference between the two sides of the bootstrap capacitor of the bootstrap circuit is over-low, so as to protect the circuit of the DC converter.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A direct current (DC) converter for converting an input voltage to an output voltage, the DC converter comprising:
a driving-stage circuit, comprising an upper switch and a lower switch, the driving-stage circuit for converting the input voltage to a switch signal according to an upper switch control signal and a lower switch control signal, and transmitting the switch signal through an output terminal;
an output-stage circuit, coupled to the output terminal of the driving-stage circuit, for converting the switch signal to the output voltage;
a bootstrap circuit, coupled between a high level voltage terminal and the output terminal of the driving-stage circuit;
an upper switch driving circuit, coupled to the driving-stage circuit and the high level voltage terminal, for generating the upper switch control signal, and
a control module, coupled to the bootstrap circuit, the upper switch driving circuit and the lower switch of the driving-stage circuit, for detecting a characteristic of the bootstrap circuit, generating the lower switch control signal accordingly, and controlling the upper switch driving circuit to generate the upper switch control signal.

2. The DC converter of claim 1, wherein the bootstrap circuit comprises a bootstrap capacitor and a diode connected in series.

3. The DC converter of claim 2, wherein the characteristic is a voltage difference between the two sides of the bootstrap capacitor.

4. The DC converter of claim 2, wherein the control module comprises:
a system signal generation unit, for generating a system signal;
a detection unit, coupled to two sides of the bootstrap capacitor, for detecting the characteristic of the bootstrap circuit, and comparing the characteristic with a reference voltage to generate a compared result; and
a control unit, coupled to the system signal generation unit and the detection unit, for generating the lower switch control signal according to the system signal and the compared result, and controlling the upper switch driving circuit to generate the upper switch control signal.

5. The DC converter of claim 4, wherein the control unit comprises:
a first low-voltage circuit, coupled to the two sides of the bootstrap circuit, for converting the characteristic of the bootstrap circuit to a current information;
a second low-voltage circuit, coupled to the first low voltage circuit, for converting the current information to a voltage information; and
a comparison unit, coupled to the second low-voltage circuit, for comparing the voltage information with the reference voltage to generating the compared result.

6. The DC converter of claim 1, wherein the output-stage circuit comprises an inductor and a capacitor, coupled between the output terminal of the driving-stage circuit and a ground terminal, for transmitting the output voltage through a node between the inductor and the capacitor.
